(19) United States
(12) Patent Application Publication
(10) Pub. No.: US 2009/0056106 A1
(43) Pub. Date: Mar. 5, 2009

(54) METHOD AND APPARATUS FOR ASSEMBLING CARRIAGE ASSEMBLY

(75) Inventor: Hiroshi Kobayashi, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/145,366

(22) Filed: Jun. 24, 2008

(30) Foreign Application Priority Data
Aug. 29, 2007 (JP) 2007-222835

(51) Int. Cl. G11B 5/10; G11B 5/48; G11B 5/84; G11B 5/54; H04R 31/00; B21B 1/46

(52) U.S. Cl. 29/603.07; 29/603.03; 29/527.1; 29/603.01

(57) ABSTRACT

Apparatus for assembling a carriage assembly includes space maintaining plates to be inserted between carriage arms fitted with suspensions. The plates have penetrating holes communicating with spacer holes provided in the suspensions. The carriage arms are held from opposite sides in the arrangement direction thereof. Pressing means force a ball having a larger diameter than the spacer holes in an axial direction of the spacer holes using a stick-like pressing member, in order to crimp the suspensions to the tips of the carriage arms. The guide members are made of an elastic material, and guide the pressing member to move substantially along the axis of the spacer holes in the crimping step. The guide members are fitted to the inner peripheral surfaces of the penetrating holes provided in the space maintaining plates.

### FIELD

The present method and apparatus relate to a method for assembling a carriage assembly used in a magnetic disk apparatus, in which suspensions are fixed to the tips of carriage arms, and an apparatus used therefore.

### BACKGROUND

FIG. 4 shows a carriage assembly used in a magnetic disk apparatus.

A plurality of carriage arms 10 are arranged parallel to each other corresponding to the surfaces of a plurality of magnetic disks in the magnetic disk apparatus. Each of the carriage arms 10 includes a fitting hole 10a at the tip. These fitting holes 10a are aligned so as to be concentric with each other. Suspensions 12 are connected to the tips of the carriage arms 10 (in FIG. 4, only one suspension 12 is shown). Magnetic heads 14 are mounted on the tips of the suspensions 12. The magnetic heads 14 are electrically connected to a controller 18 through a flexible substrate 16 attached to side surfaces of the carriage arms 10. The base portions of the carriage arms 10 are fixed to an actuator axis 19. Rotation of the actuator axis 19 causes the carriage arms 10 to perform a seek operation in planes parallel to the surfaces of recording media.

The carriage assembly is assembled by crimping the suspensions 12 to both the top and bottom surfaces of the tips of the parallel carriage arms 10, which are fixed to the actuator axis 19.

Japanese Unexamined Patent Application Publication No. 2004-127491 discloses a method for fixing suspensions 12 to carriage arms 10, which is shown in FIGS. 5 and 6.

In this method, first, the suspensions 12 are fitted to both the top and bottom surfaces of the carriage arms 10, while aligning spacer holes 12b provided in spacer portions 12a of the suspensions 12 with fitting holes 10a provided in the tips of the carriage arms 10. Then, using a pressing shaft 22 serving as a pressing member, a metal ball 20 having a diameter slightly larger than the diameter of the spacer holes 12b is pressed through the spacer holes 12b. The metal ball 20, being pressed by the pressing shaft 22, passes through the fitting holes 10a arranged one above the other and the spacer holes 12b aligned with the fitting holes 10a, as shown in FIG. 5.

Because the metal ball 20 has a slightly larger diameter than the spacer holes 12b, the metal ball 20 deforms crimping portions 13 provided on the inner peripheries of the spacer holes 12b as it passes through the spacer holes 12b. Thus, the spacer portions 12a of the suspensions 12 bite into the carriage arms 10, whereby they are fixedly crimped together.

As described above, in assembling the carriage assembly, the suspensions 12 are fixedly crimped to the carriage arms 10 by using the metal ball 20 to enlarge the spacer holes 12b. This has resulted in a problem in that the stress acting on the spacer portions 12a during crimping deforms the spacer portions 12a, displacing the suspensions 12 from their standard positions. That is, the flatness of the spacer portions 12a may be degraded when the suspensions 12 are crimped to the carriage arms 10, resulting in displacements of the suspensions 12 from their standard angle. Such displacements of the suspensions 12 may affect and vary the flying height of the magnetic heads 14 from the surfaces of the recording media.

As the recording density of magnetic disk apparatuses has become extremely high these days, the flying heights of magnetic heads from the surfaces of the recording media have been reduced. As a result, a variation in flying height of magnetic heads significantly affects the information reading and writing properties of a magnetic disk apparatus. Therefore, there is a demand for reducing a variation in flying height of magnetic heads to achieve required reading and writing properties.

Japanese Unexamined Patent Application Publication No. 2004-127491 also discloses a method for assembling a carriage assembly in which deformations of the spacer portions 12a due to the stress acting thereon during crimping are reduced. FIG. 7 shows the method disclosed therein, in which an ultrasonic horn 32 is used to suppress such deformations.

The method is characterized in that the ultrasonic horn 32 presses the metal ball 20 through the spacer holes 12b. The metal ball 20 used in this method is the same one as used in the above-mentioned method. In FIG. 7, which shows a state during assembly, the carriage arms 10, the spacer portions 12a of the suspensions 12, and space maintaining plates 36 inserted between the carriage arms 10 are supported by pressurizing plates 37a and 37b from opposite sides.

The ultrasonic horn 32 applies an ultrasonic vibration in the axial direction to reduce the damage on the spacer portions 12a caused by the metal ball 20 during crimping. This prevents the suspensions 12 from being deformed when mounted to the carriage arms 10, and enables the suspensions 12 to be more precisely fixed to the carriage arms 10. Possible reasons why the suspensions 12 can be fixed to the carriage arms 10 without being deformed are that the superposition of the ultrasonic vibration stress caused by the ultrasonic horn 32 and the static stress caused by the metal ball 20 enlarging the crimping portions 13 reduces the deformation resistance, and application of high-speed repeated impacts reduces the average machining force.

For more information, see Japanese Unexamined Patent Application Publication No. 2004-127491 (paragraphs 0003-0004, 0015, and 0023-0024, FIGS. 3, 5 and 6)

### SUMMARY

The method for assembling a carriage assembly comprises, fitting suspensions to tips of carriage arms that are arranged parallel to each other and usable in a magnetic disk apparatus, the suspensions each having a spacer portion provided with a spacer hole, the carriage arms having fitting holes concentric with each other, the suspensions being fitted to the tips of the carriage arms such that the spacer holes are aligned with the fitting holes; holding the carriage arms by inserting space maintaining plates between the carriage arms and clamping the carriage arms from opposite sides in the arrangement direction thereof, the space maintaining plates having penetrating holes that communicate with the spacer holes; and crimping the suspensions to the tips of the carriage arms by pressing a ball successively through the spacer holes provided in the suspensions using a stick-like pressing member so as to deform peripheral portions of the spacer holes provided in the spacer portions, the ball having a diameter larger than or equal to a diameter of the spacer holes, wherein inner peripheral surfaces of the penetrating holes in the space maintaining plates are fitted with guide members made of an elastic material, the guide members guiding the pressing member in the crimping step so that the pressing member moves substantially along an axis of the spacer holes.

### BRIEF DESCRIPTION OF THE DRAWINGS

FIG. 1 shows a method and apparatus for assembling a carriage assembly according to a first embodiment;

FIG. 2 shows a method and apparatus for assembling a carriage assembly according to a second embodiment;

FIG. 3 shows a variation example of the method and apparatus for assembling a carriage assembly according to a second embodiment;

FIG. 4 shows an external view of a carriage assembly;

FIG. 5 shows that a metal ball (ball) is caused to pass through spacer holes provided in suspensions to crimp the suspensions to carriage arms;

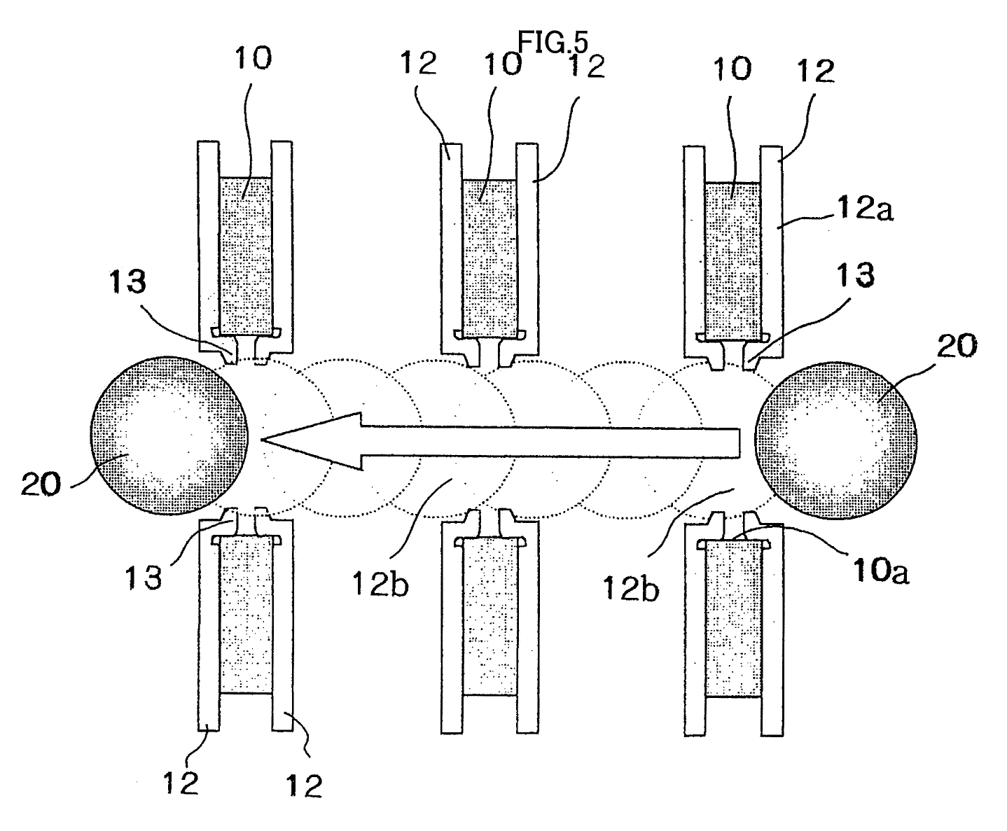

FIG. 6 is a known method for assembling a carriage assembly;

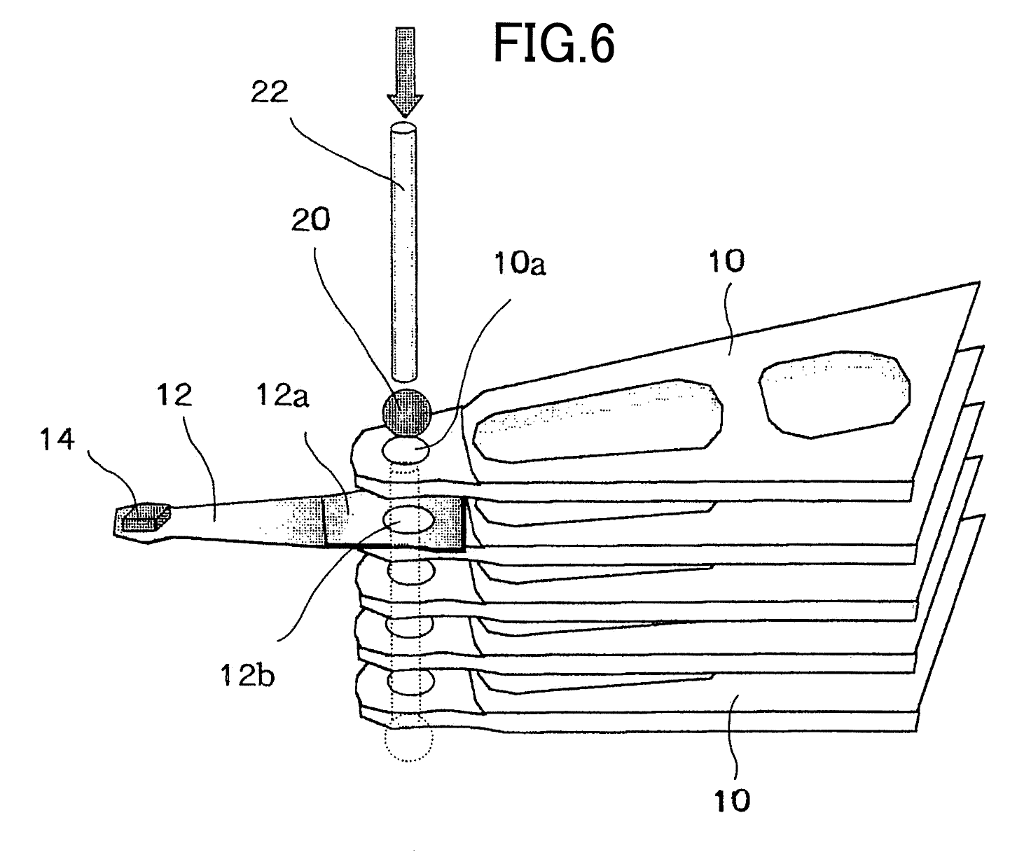

FIG. 7 shows a known method for assembling a carriage assembly;

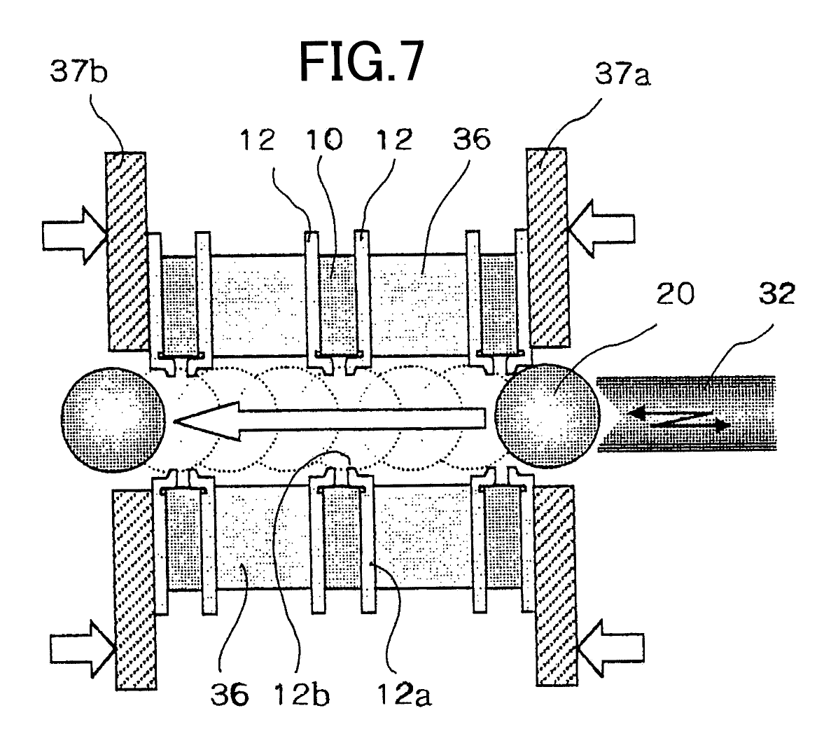

FIG. 8 shows the known method for assembling a carriage assembly, illustrating a bent pressing member (ultrasonic horn);

### DETAILED DESCRIPTION OF THE EMBODIMENTS

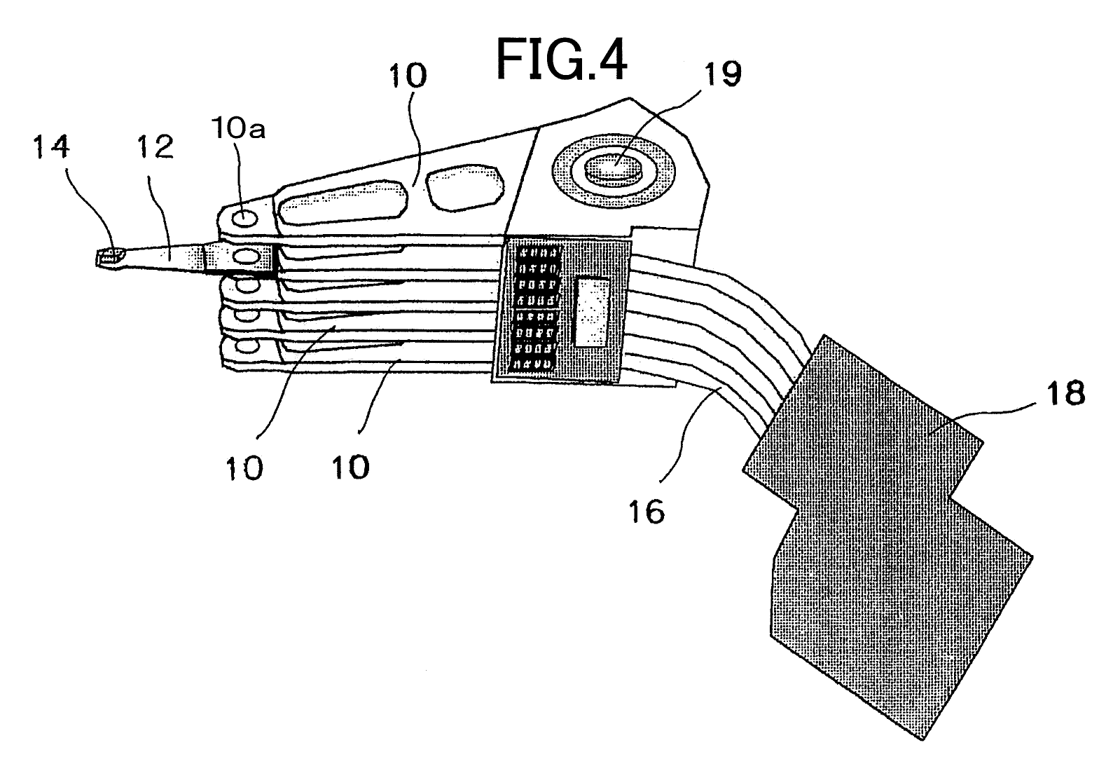

A carriage assembly that is a subject of the method and the apparatus for assembling the carriage assembly according to this embodiment is the same carriage assembly shown in FIG. 4, and a structure thereof has been described in connection with the conventional technique. Thus, a description thereof will not be made.

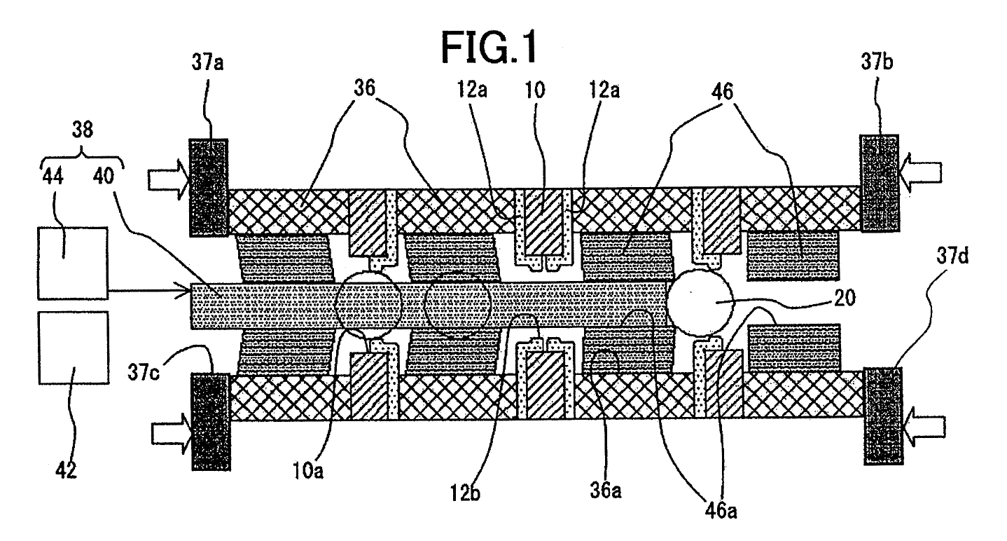

FIG. 1 shows a method and apparatus for assembling a carriage assembly according to a first embodiment. The apparatus for assembling a carriage assembly according to the first embodiment includes pressurizing plates 37a and 37b serving as carriage holding means, space maintaining plates 36 each having a penetrating hole 36a provided therein, pressing means 38 for pressing a metal ball 20, guide members 46 fitted to the inner peripheral surfaces of the penetrating holes 36a provided in the space maintaining plates 36, and an ultrasonic-wave generating unit 42 serving as ultrasonic vibration applying means for applying an ultrasonic vibration to the metal ball 20 through a pressing member 40.

The carriage arms 10, the space maintaining plates 36 inserted between the carriage arms 10, and the spacer portions 12a of the suspensions 12 fitted to the carriage arms 10, align spacer holes 12b provided in the suspensions 12 with the fitting hole 10a provided in the tips of the carriage arms 10, and are supported by the pressurizing plates 37a and 37b from opposite sides in the arrangement direction so as to be sandwiched (clamped) by them.

The penetrating holes 36a provided in the space maintaining plates 36 communicate with the fitting holes 10a and the spacer holes 12b, when the space maintaining plates 36 are interposed between the carriage arms 10.

The pressurizing plates 37a and 37b have openings 37c and 37d, respectively, which also communicate with the fitting holes 10a and the spacer holes 12b, when the pressurizing plates 37a and 37b clamp the carriage arms 10, the suspensions 12, and the space maintaining plates 36.

The pressing means 38 includes the pressing member 40 (ultrasonic horn) having a stick (or column) shape, and a driving unit 44. The driving unit can have a motor and a ball screw that converts the motor's rotation to a linear motion. The driving unit 44 moves the pressing member 40 along its axis by the linear motion, into and out of the fitting holes 10a provided in the carriage arms 10 and the spacer holes 12b aligned with the fitting holes 10a, which are clamped by the pressurizing plates 37a and 37b.

The ultrasonic-wave generating unit 42 includes an ultrasonic vibrator coupled to the pressing member 40, and applies an ultrasonic vibration to the pressing member 40 by vibrating the ultrasonic vibrator. Although the vibration direction of the ultrasonic vibration applied by the ultrasonic-wave generating unit 42 is not exactly limited, it is preferably the axial direction of the pressing member 40 (so-called longitudinal wave).

Each of the guide members 46 has a ring (or tube) shape with a guide hole 46a provided therein. The outer peripheral surfaces of the guide members 46 are fitted to the inner peripheral surfaces of the penetrating holes 36a provided in the space maintaining plates 36, so as to be concentric with each other. In addition, the guide holes 46a have a smaller diameter than the spacer holes 12b. Preferably, a diameter of the guide holes 46a and a diameter of the pressing member 40 are substantially the same.

The guide members 46 are made of an elastic material such as rubber. More specifically, the guide members 46 may be made of nitrile rubber (NBR), styrene-butadiene rubber (SBR), or the like.

The inner peripheral surfaces of the guide holes 46a provided in the guide members 46, i.e., the guide surfaces with which the outer peripheral surface of the pressing member 40 comes into contact, are provided with a coating film made of a material harder than the elastic material constituting the guide members 46. Examples of materials of this coating film include polyimide, fluorocarbon resin, and engineering plastic. These materials make a durable and low-friction coating film.

A method for assembling a carriage assembly using the apparatus for assembling a carriage assembly according to the first embodiment will now be described.

### Fitting Step

The suspensions 12 are fitted to both sides of the carriage arms 10 arranged parallel to each other, except for the outermost carriage arms 10, while aligning the spacer holes 12b provided in the suspensions 12 with the fitting holes 10a provided in the tips of the carriage arms 10.

### Holding Step

The carriage assembly is then held by the apparatus for assembling a carriage assembly. As shown in FIG. 1, the carriage arms 10, the spacer portions 12a of the suspensions 12, and the space maintaining plates 36 are interposed between the carriage arms 10 and held by the pressurizing plates 37a and 37b from opposite sides in the arrangement direction.

### Crimping Step

The pressing means 38 presses the metal ball 20 through the spacer holes 12b.

First, the metal ball 20 is aligned with the spacer hole 12b provided in the suspension 12 fitted to one of the outermost carriage arms 10 (in the present embodiment, the carriage arm 10 adjacent to the pressurizing plate 37a), and is positioned on one side of the spacer hole 12b. Then, the driving unit 44 moves and controls the pressing member 40 so that the tip of the pressing member 40 contacts the metal ball 20, and inserts the pressing member 40 into the spacer holes 12b. The ultrasonic-wave generating unit 42 is actuated and applies an ultrasonic vibration to the pressing member 40, while the metal ball 20 successively passes through the spacer holes 12b.

By applying the ultrasonic vibration to the pressing member 40, the carriage assembly can be assembled while suppressing the deformations of the spacer portions 12a of the suspensions 12 and the carriage arms 10.

Because the metal ball 20 has a slightly larger diameter than the spacer holes 12b, the metal ball 20 deforms the crimping portions 13 provided on the inner peripheries of the spacer holes 12b as it passes through the spacer holes 12b. Thus, the spacer portions 12a of the suspensions 12 bite into the carriage arms 10, whereby they are fixedly crimped together.

In the method for assembling a carriage assembly according to the first embodiment, the metal ball 20 and the pressing member 40 pass through the guide holes 46a provided in the guide members 46, in the crimping step. The diameter of the guide holes 46a is, as described above, smaller that the diameter of the spacer holes 12b and substantially the same diameter as the diameter of the pressing member 40. That is to say, the diameter of the guide holes 46a is smaller than the diameter of the metal balls 20. However, the guide members 46 are made of elastic material, so the metal ball 20 passes through the guide holes 46a with the guide members 46 deforming elastically by being pressed by the pressing member 40.

Since the diameter of the guide holes 46a is smaller than that of the spacer holes 12b, the pressing member does not touch the inner peripheral surface of the spacer holes 12b. After the metal ball 20 passes through the guide members 46 provided in the guide holes 46a, the guide members 46 go back into their original shape owing to their elasticity, and guide the pressing member 40 so as to move along the axis of the spacer holes 12b by the inner peripheral surfaces (guide surfaces) of the guide holes 46a.

Since the diameter of the guide holes 46a is smaller that that of the spacer holes 12b (more preferably, substantially the same as the diameter of the pressing member 40), collision upon the inner peripheral surface of the spacer holes 12b provided in the spacer portions 12a by the pressing member 40 can be avoided.

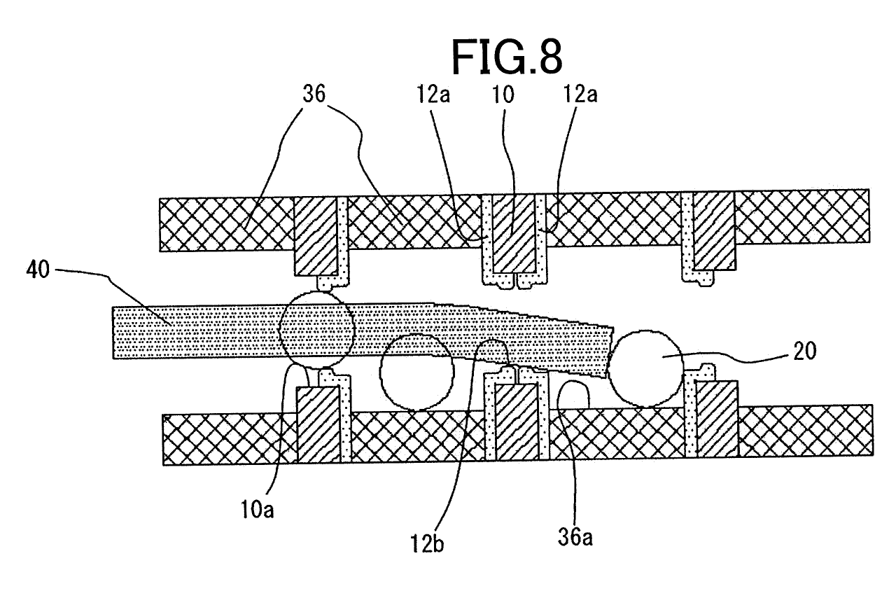

Likewise, the metal ball 20 is also guided to move along the axis of the spacer holes 12b (the fitting holes 10a) by the guide member 46. This prevents the metal ball 20 from interfering with the spacer portions 12a in the areas other than the peripheral portions of the spacer holes 12b, and avoids collision between the metal ball 20 or the pressing member 40 and the spacer portions 12a shown in FIG. 8.

The guide surfaces of the guide members 46 can be provided with a coating film, so the elastic material of the guide members 46 does not produce dust due to friction between the elastic material and the pressing member 40. The coating film also serves to increase the slippage of the guide surfaces of the guide members 46, and reduce the stress acting on the guide members 46, i.e., the frictional resistance of the guide members 46, which hinders the pressing member 40 and the metal ball 20 from advancing.

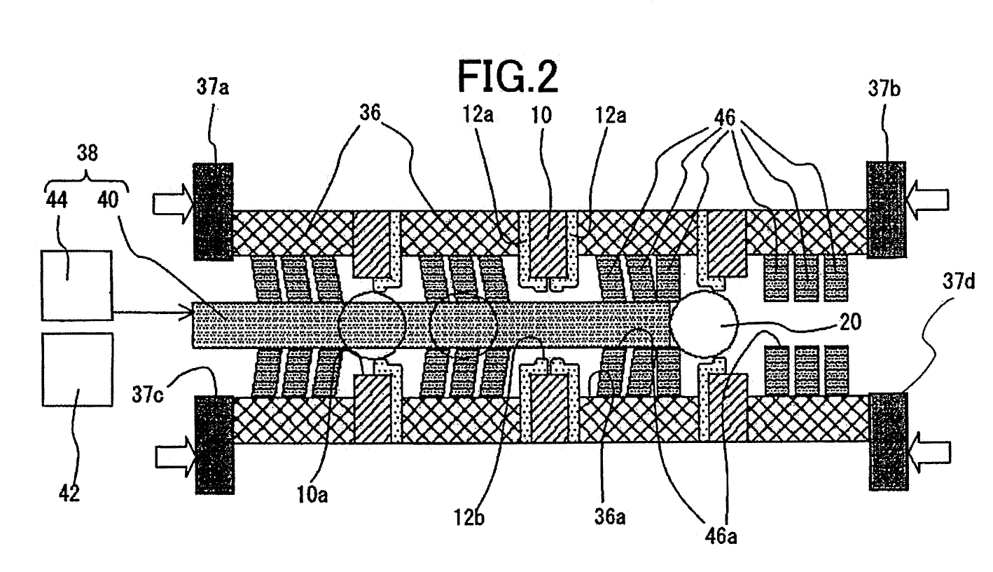

FIG. 2 shows the method and apparatus for assembling a carriage assembly according to the second embodiment. The structure of the guide members 46 according to the second embodiment is different from that according to the first embodiment. Because the other structures are the same as those according to the first embodiment, the description therefore will not be made here.

In the apparatus for assembling a carriage assembly according to the second embodiment, each of the space maintaining plates 36 is provided with a plurality (three) of guide members 46 arranged in the axial direction of the penetrating holes 36a. Each of the guide members 46 has a ring shape, and is made of a disc-shaped elastic member with the guide hole 46a provided therein.

Similar to the first embodiment, the outer peripheral surfaces of the guide members 46 are fitted to the inner peripheral surfaces of the penetrating holes 36a provided in the space maintaining plates 36, and the guide holes 46a and the penetrating holes 36a are aligned so as to be concentric with each other. The diameter of the guide holes 46a is smaller than that of the spacer holes 12b. Preferably, the inner diameter of the guide holes 46a is substantially the same diameter as the diameter of the pressing member 40.

Because each of the space maintaining plates 36 is provided with the plurality of guide members 46 arranged in the axial direction of the penetrating holes 36a, the thickness (the length in the axial direction of the guide holes 46a) of each of the guide members 46 can be reduced. Steps in the method for assembling a carriage assembly according to the second embodiment are the same as those according to the first embodiment, except for the structure of the guide members 46.

In the method and apparatus for assembling a carriage assembly according to the second embodiment, when compared with those according to the first embodiment shown in FIG. 1, the thickness (the length in the axial direction of the guide holes 46a) of the guide members 46 is smaller. Thus, the guide members 46 are easily deformed, reducing the stress acting on the guide members 46, i.e., the frictional resistance of the guide members 46, which hinders the pressing member and the metal ball 20 from advancing.

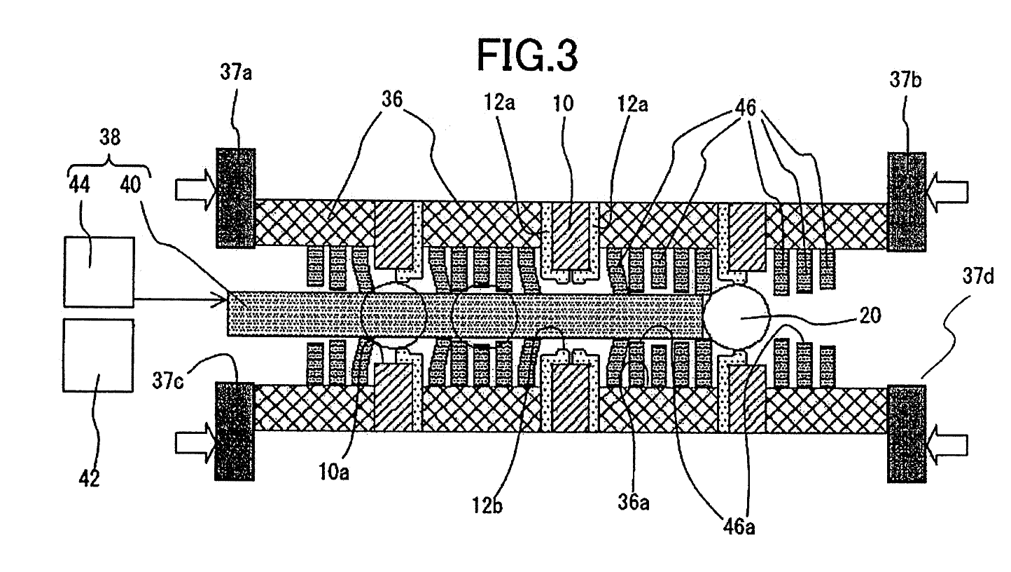

FIG. 3 shows a variation example of the apparatus for assembling a carriage assembly according to the second embodiment. In this variation example, each of the space maintaining plates 36 is provided with as many as five guide members 46 in the axial direction of the penetrating holes 36a. The guide members 46 fitted to each of the penetrating holes 36a provided in the space maintaining plates 36 become longer as their positions near both sides of the penetrating holes 36a, i.e., the positions adjacent to the spacer 12a, so as to narrow the guide holes 46a.

This structure prevents the pressing member 40 from touching the suspensions 12. More specifically, the pressing member 40 can be prevented from touching the suspensions 12 placed at the far left and the middle of the assembly when the pressing member 40 crimps the suspensions 12.

In addition, the force needed to urge the pressing member 40 to move along the guide position (along the axis above-mentioned) gradually increases at the guide member 46 near the spacers 12a. Meanwhile, the force needed to urge the pressing member 40 and the metal ball 20 gradually decreases at the guide members 46 distant from the spacers 12a. Therefore, the stress acting on the pressing member 40 and the metal ball 20, i.e., the frictional resistance of the guide members 46 that are distanced from the spacers 12a, which hinders the pressing member 40 and the metal ball 20 from advancing, can be reduced, yet still preventing the pressing member 40 from touching the inner periphery of the spacer holes 12b.

In the second embodiment, each of the penetrating holes 36a provided in the space maintaining plates 36 is provided with a plurality of the guide members 46. The guide members 46 may be made of a harder elastic material as their positions near the sides of the penetrating holes 36a, i.e., the positions adjacent to the spacers 12a. For example, the guide members 46 on both sides of the penetrating holes 36a may be made of a rubber material having a hardness of about 90, and the guide member 46 at the middle may be made of a rubber material having a hardness of about 50. Again, the guide members 46 may be made of a rubber material having different hardnesses ranging from 90 to 50 that decrease from the edge to the middle.

Further, by making the diameter of selected guide holes 46a narrower and making the guide members 46 of the harder elastic material at positions near the both sides of the penetrating hole 36a (the positions adjacent to the spacers 12a in the crimping step), the force can be more effectively applied.

What is claimed is:

1. A method for assembling a carriage assembly, comprising:
fitting suspensions to tips of carriage arms that are arranged parallel to each other and usable in a magnetic disk apparatus, the suspensions each having a spacer portion provided with a spacer hole, the carriage arms having fitting holes concentric with each other, the suspensions being fitted to the tips of the carriage arms such that the spacer holes are aligned with the fitting holes;
holding the carriage arms by inserting space maintaining plates between the carriage arms and clamping the carriage arms from opposite sides in the arrangement direction thereof, the space maintaining plates having penetrating holes that communicate with the spacer holes; and
crimping the suspensions to the tips of the carriage arms by pressing a ball successively through the spacer holes provided in the suspensions using a stick-like pressing member so as to deform peripheral portions of the spacer holes provided in the spacer portions, the ball having a diameter larger than or equal to a diameter of the spacer holes,
wherein inner peripheral surfaces of the penetrating holes in the space maintaining plates are fitted with guide members made of an elastic material, the guide members guiding the pressing member in the crimping step so that the pressing member moves substantially along an axis of the spacer holes.

2. The method according to claim 1,
wherein the guide members each have a ring shape having a guide hole whose inner peripheral surface guides the pressing member.

3. The method according to claim 2,
wherein a diameter of each of the guide holes is equal to a diameter of the pressing member.

4. The method according to claim 2,
wherein each of the space maintaining plates is fitted with a plurality of the guide members arranged in an axial direction of the penetrating holes, and
the guide members have diameters that gradually decrease as their positions approach both sides of the penetrating holes.

5. The method according to claim 4,
wherein the guide members are made of elastic materials whose hardnesses increase as their positions approach both sides of the penetrating holes.

6. The method according to claim 1,
wherein the guide members have guide surfaces to contact the pressing member, the guide surfaces being provided with a coating film made of a material harder than the elastic material constituting the guide members.

7. An apparatus for assembling a carriage assembly used in the method for assembling a carriage assembly according to claim 1, the apparatus comprising:
the space maintaining plates to be inserted between the carriage arms fitted with the suspensions, the space maintaining plates having the penetrating holes communicating with the spacer holes provided in the suspensions;
carriage holding means for holding the carriage arms from the opposite sides in the arrangement direction thereof, so as to clamp the carriage arms;
pressing means for pressing the ball having a larger diameter than the spacer holes in an axial direction of the spacer holes using the stick-like pressing member, so as to move the ball successively through the spacer holes provided in the suspensions and deform the peripheral portions of the spacer holes provided in the spacer portions, in order to crimp the suspensions to the tips of the carriage arms; and
the guide members made of an elastic material, for guiding the pressing member to move substantially along the axis of the spacer holes in the crimping step, the guide members being fitted to the inner peripheral surfaces of the penetrating holes provided in the space maintaining plates.
